(19) United States
(12) Patent Application Publication
(10) Pub. No.: US 2011/0317954 A1
(43) Pub. Date: Dec. 29, 2011

(54) Motor Vehicle Bump Stop Comprising a Set of at Least Two Mounted Seal Rings

(75) Inventor: Ludovic Saunier, Saint Felix (FR)

(73) Assignee: NTN-SNR ROULEMENTS, Annecy (FR)

(21) Appl. No.: 13/170,442

(22) Filed: Jun. 28, 2011

(30) Foreign Application Priority Data
Jun. 29, 2010 (FR) 10 02714

(51) Int. Cl. F16C 33/76; F16C 19/30

(52) U.S. Cl. 384/607

(57) ABSTRACT

A motor vehicle bump stop has an upper retainer, a lower retainer and rolling bodies arranged between the retainers to enable the relative rotation thereof, the retainers are arranged to form together at least one annular space defined laterally by two respectively inner and outer axial walls. The stop has a set of at least two mounted seal rings stacked axially in the space with an axial clearance. The rings are mounted on the inner or outer wall and form a radial clearance with the outer or inner wall, so as to form a sealing baffle in the space.

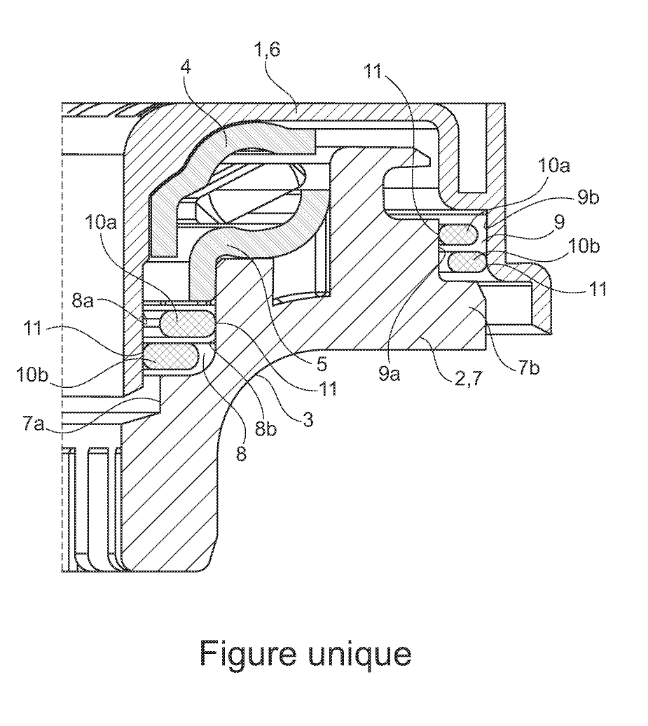

### BACKGROUND

The invention relates to a motor vehicle bump stop, particularly to be integrated in a suspension strut of a motor vehicle steering wheel.

The invention is applicable to a bump stop comprising a fixed upper retainer to be associated with the vehicle body, a rotary lower retainer comprising a support for the suspension spring and rolling bodies arranged between said retainers to enable the relative rotation thereof.

To prevent leakages of lubricant present in the bearing space and the contamination of said space with external pollutants, the use of seals comprising a flexible sealing element which is fixed or integrated in one of the retainers so as to be in friction contact on the other retainer is known.

This embodiment particularly involves the drawback of inducing a friction torque during the relative rotation of the retainers, which is detrimental for the use of the stop in steering wheel assembly.

To solve this problem, the document WO-2009/019340relates to a sealing element arranged in friction contact on each of the retainers, said sealing element being movably mounted with respect to at least one retainer. This provides a particularly satisfactory compromise between the sealing function and the torque induced, even in the event of deformation of the stop under the effect of the forces applied.

However, when the sealing element is radially movable, this embodiment envisages the formation of a radial groove in a retainer, complicating the embodiment of said retainer, particularly by requiring the use of a movable member during the moulding of said retainer.

Moreover, the movable mounting of the sealing element in the groove limits the embodiment of said element, particularly by requiring same to be folding or deformable.

### SUMMARY

The invention aims to enhance the prior art particularly by providing a sealed bump stop which is simple to embody and mount, while retaining an optimal compromise between the sealing function and the torque induced.

For this purpose, the invention relates to a motor vehicle bump stop, said stop comprising an upper retainer, a lower retainer and rolling bodies arranged between said retainers to enable the relative rotation thereof, said retainers being arranged to form together at least one annular space defined laterally by two respectively inner and outer axial walls, said stop comprising a set of at least two mounted seal rings stacked axially in said space with an axial clearance, said rings being mounted on the inner—or outer—wall and forming a radial clearance with the outer—or inner—wall, so as to form a sealing baffle in said space.

### BRIEF DESCRIPTION OF THE DRAWING

Further features and advantages of the invention will emerge in the description hereinafter, with reference to the attached FIGURE representing partially and in an axial section a bump stop according to one embodiment of the invention.

### DETAILED DESCRIPTION OF THE PREFERRED EMBODIMENT(S)

In this description, the terms spatial positioning are used with reference to the axis of rotation of the bump stop (vertical in the figure showing one side of the section, the other side being symmetrical with respect to said axis). In particular, the term “inner” relates to an arranged near this axis and the term “outer” relates to an arrangement at a distance for this axis. Moreover, the terms “upper” and “lower” relate to the arrangement of the stop as represented in the FIGURE.

A motor vehicle wheel, particularly a steering wheel, is mounted on the chassis via a strut enabling the suspension of the body in relation to the ground. For this purpose, the strut conventionally comprises a shock absorber, a suspension spring and a bump stop whereon the spring rests.

With reference to the figure, an embodiment is described below of a bump stop comprising a fixed upper retainer 1 to be associated with the vehicle body, a rotary lower retainer 2 comprising a support 3 for the suspension spring and the rolling bodies (not shown) arranged between said retainers to enable the relative rotation thereof about an axis. In this way, when the spring is compressed and released, the winding of the turns thereof on each other is modified, causing the rotation of the lower retainer 2. Furthermore, locking the wheels also induces a rotation of the lower retainer 2.

In the embodiment shown, the upper 1 and lower 2 retainers each comprise a washer 4, 5, particularly made of buckled sheet, provided with a respectively lower and upper bearing for the rolling bodies.

The stop further comprises two lining parts 6, 7, particularly produced by moulding a rigid thermoplastic material, for example polyamide 6.6. These parts are, respectively, an associated cover 6 on the upper washer 4 to be inserted between the chassis and said upper washer, and an associated supporting member 7 under the lower washer 5, said supporting member comprising the spring support 3. These lining parts 6, 7 particularly make it possible to absorb the forces from spring and, if required, those of the bump stop.

In the embodiment shown, the supporting member 7 is surrounded by the cover 6 so as to form two respectively inner 8 and outer 9 annular spaces. Each of the annular space 8, 9 is defined laterally by two respectively inner 8a, 9a and outer 8b, 9b walls, the inner 8a and outer 8b of the inner annular space 8 being formed on respectively the cover 6 and the supporting member 7, the inner 9a and outer 9b walls of the outer annular space 9 being formed on respectively the supporting member 7 and the cover 6. In particular, the annular spaces 8, 9 have a radial clearance so as to enable the rotation of the supporting member 7 with respect to the cover 6 with no interference between same.

The bump stop comprises a set of at least two mounted seal rings 10 stacked axially in an annular space 8, 9 having an axial clearance. In particular, the seal rings 10 may be made, particularly by moulding, of a rigid polymeric material such as polyethylene, polypropylene, polyamide 6, 6.6, 11 or 12, polyoxymethylene (POM).

In the embodiment shown, the two annular spaces 8, 9 are fitted with a set of two seal rings 10 so as to seal both sides of the bump stop. However, it may be envisaged that only one inner 8 or outer 9 annular space is fitted with a set of seal rings 10, the other optionally being fitted with a sealing device known from the prior art.

The seal rings 10 are mounted on the inner 8a, 9a—or outer 8b, 9b—wall and form a radial clearance with the outer 8b, 9b—or inner 8a, 9a—wall, so as to form a sealing baffle in the annular space 8, 9. In particular, a baffle mounted on the stop makes it possible not to restrict the embodiment of the cover 6 and/or supporting member 7, particularly by not requiring the use of a movable member for the formation of a radial groove.

In one example of an embodiment, the axial clearance between the seal rings 10 of a set may be between 1.2 and 2.4 mm and the radial overlap between said rings may be between 0.8 and 1.6 mm.

In the embodiment shown, the upper rings 10a are jointed onto the supporting member 7 and the lower rings 10b are jointed onto the cover 6. In an alternative embodiment not known, a set may comprise a stack of more than two seal rings 10, said rings being mounted in alternation on the axial walls 8a, 8b; 9a, 9b so as to increase the sinuosity of the baffle formed.

Advantageously, at least one seal ring 10 is mounted on the axial wall 8a, 8b; 9a, 9b with the option of axial movement. In particular, both seal rings 10 can move axially on the respective mounting wall thereof, particularly under the effect of the deformations of the cover 6 in relation to the supporting member 7 induced by the mechanical strains applied to the bump stop as part of the use thereof.

In this way, it is possible to combine the sealing function provided by the baffle with torque limitation due to the option of the movement of the seal rings 10 with respect to at least one retainer 1, 2. Furthermore, the movements of the seal rings 10 limit the wear thereof and prevent the risk of the jamming thereof following stop deformations.

In the embodiment shown, each ring 10 has a jointing surface 11 on the axial wall 8a, 8b; 9a, 9b, the diameter of said surface being substantially equal to that of said wall so as to enable axial sliding of said surface on said wall.

Furthermore, the supporting member 7 has two extensions 7a, 7b extending radially under respectively an annular space 8, 9 so as to keep the set of seal rings 10 inside said space. Besides the axial stop function thereof for the seal rings 10, each extension 7a, 7b is arranged facing the cover 6 with reduced clearance to limit the access of pollutants in each of the annular spaces 8, 9. In an alternative embodiment not shown, at least one extension can be formed on the cover 6 to keep the set of seal rings 10 and/or to form reduced clearance with the supporting member 7.

Moreover, the jointing surfaces 11 have a bevelled geometry to reduce the interference of jointing on the axial wall 8a, 8b; 9a, 9b. This favours the axial movement and pivoting of the seal ring 10 with respect to the mounting wall 8a, 8b; 9a, 9b thereof.

The stop shown is mounted by stacking the rings 10 of a set on the supporting member 7, the surfaces 11 of the upper rings 10a being jointed on the axial walls 8b, 9a of said supporting member. The cover 6 is then mounted on the supporting member 7 jointing the surfaces 11 of the lower rings 10b on the axial walls 8a, 9b of said cover. In particular, the jointing produced do not require stretching of the seal rings 10 so as not to limit the choice of the material forming said rings.

In this embodiment, the diameter of the seal rings 10 of a set being very similar, it is possible to envisage visual foolproof means, for example that the rings 10 of a set are not the same colour and/or have a marking depending on whether they are upper 10a or lower 10b. This renders the seal rings 10 distinguishable so as to limit the possibility of inversion during the mounting thereof on the supporting member 7.

1-10. (canceled)

11. A motor vehicle bump stop comprising an upper retainer, a lower retainer and rolling bodies arranged between said upper and lower retainers to enable relative rotation thereof, said upper and lower retainers being arranged to form together at least one annular space defined laterally by two respectively inner and outer axial walls, a set of at least two mounted seal rings stacked axially in said at least one annular space with an axial clearance, said at least the seal rings being mounted on one of the inner and outer walls and forming a radial clearance with the other of the outer or inner walls, so as to form a sealing baffle in the at least one annual space.

12. The bump stop according to claim 11, wherein at least one seal ring is mounted on one of the axial walls with an option of axial movement.

13. The bump stop according to claim 12, wherein the at least one seal ring has a jointing surface on the one axial wall, and a diameter of said jointing surface being substantially equal to a diameter of said one wall so as to enable axial sliding of said jointing surface on said one wall.

14. The bump stop according to claim 13, wherein the jointing surface has a bevelled geometry to reduce jointing interference on the one axial wall.

15. The bump stop according to claim 11, wherein at least one retainer has an extension extending under the at least one annular space so as to hold the set of seal rings inside said at least one annular space.

16. The bump stop according to claim 15, wherein the extension is arranged opposite the other retainer with reduced clearance to limit access of pollutants into the at least one annular space.

17. The bump stop according to claim 11, wherein the bump stop has two inner and outer annular spaces, respectively, each of said annular spaces being equipped with a set of seal rings.

18. The bump stop according to claim 11, wherein the seal rings of one set comprise visual keyway means.

19. The bump stop according to claim 11, wherein the upper and lower retainers each comprise a washer provided with a respectively lower and upper bearing for the rolling bodies, and wherein said stop further comprises two lining parts, an associated cover on the upper washer and an associated supporting member under the lower washer, and the at least one annular space being provided between said cover and said supporting member.

20. The bump stop according to claim 11, wherein the seal rings are made of rigid polymeric material.
